(19) United States
(12) Patent Application Publication
(10) Pub. No.: US 2024/0072994 A1
(43) Pub. Date: Feb. 29, 2024

(54) UNIKERNELS FOR PRIVATE/PUBLIC KEY DISTRIBUTION

(71) Applicant: Red Hat, Inc., Raleigh, NC (US)

(72) Inventors: Leigh Griffin, Waterford (IE); Luigi Mario Zuccarelli, Cork (IE)

(21) Appl. No.: 17/898,564

(22) Filed: Aug. 30, 2022

(51) Int. Cl. H04L 9/08; H04L 9/14; H04L 9/30; H04L 9/40

(52) U.S. Cl. CPC H04L 9/0819; H04L 9/0894; H04L 9/14; H04L 9/3073; H04L 63/1433

(57) ABSTRACT

An identifier for a public unikernel of a plurality of public unikernels is provided to a client computing system, the public unikernel storing a first key paired to a second key stored within a private unikernel of a plurality of private unikernels accessible to a server computing system that serves the client computing system. An encoding based on the identifier for the public unikernel is generated, the encoding being configured to identify, to the server computing system, the private unikernel that stores the second key. The encoding is provided to the server computing system.

### BACKGROUND

A unikernel is a specialized, single-address-space machine image that is constructed using library operating systems. Generally, unikernels are constructed for a single function, or purpose (e.g., to run a specific application, provide a single microservice, etc.), and only include the libraries necessary to fulfill that function. For example, if a unikernel is constructed to provide a network microservice, it would probably not require libraries that enable user input devices. In some instances, unikernels can be constructed to store a particular piece of data. For example, a unikernel may be constructed to store a network address. When a system executes the unikernel, the unikernel can inject, or otherwise provide, the network address into the executing system.

### SUMMARY

The examples implement mechanisms for distribution of public/private key pairs via unikernels. An identifier for a public unikernel of a plurality of public unikernels can be provided to a client computing system. The public unikernel can store a first key paired to a second key. The second key can be stored within a private unikernel of a plurality of private unikernels (e.g., a private unikernel registry, etc.). The plurality of private unikernels can be accessible to a server computing system that serves the client computing system. An encoding can be generated based on an identifier for the public unikernel. The encoding can be configured to identify the private unikernel that stores the second key to the server computing system. The encoding can be provided to the server computing system.

In one example a method is provided. The method includes providing, by a controller computing system comprising one or more processor devices, an identifier for a public unikernel of a plurality of public unikernels to a client computing system, the public unikernel storing a first key paired to a second key stored within a private unikernel of a plurality of private unikernels accessible to a server computing system that serves the client computing system. The method includes generating an encoding based on the identifier for the public unikernel, the encoding being configured to identify, to the server computing system, the private unikernel that stores the second key. The method includes providing the encoding to the server computing system.

In another example, a computing system is provided. The computing system includes memory. The computing system includes one or more processor devices coupled to the memory. The one or more processors are to receive an encoding that identifies a private unikernel of a plurality of private unikernels accessible to the server computing system, the private unikernel storing a second key that is paired to a first key. The one or more processors are to execute the private unikernel to obtain the second key. The one or more processors are to receive encoded data that is encoded using the first key from a client computing system served by the server computing system. The one or more processors are to decode the encoded data using the second key.

In yet another example, a non-transitory computer-readable storage medium is provided. The non-transitory computer-readable storage medium includes executable instructions. The executable instructions are to cause a processor device to provide an identifier for a public unikernel of a plurality of public unikernels to a client computing system, the public unikernel storing a first key paired to a second key stored within a private unikernel of a plurality of private unikernels accessible to a server computing system that serves the client computing system. The executable instructions are to cause a processor device to generate an encoding based on the identifier for the public unikernel, the encoding being configured to identify, to the server computing system, the private unikernel that stores the second key. The executable instructions are to cause a processor device to provide the encoding to the server computing system.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing public/private key distribution via unikernels according to some implementations of the present disclosure.

FIG. 2 is a flowchart of a method for distributing public/private key pairs via unikernels according to some implementations of the present disclosure.

FIG. 3 is a simplified block diagram of the environment illustrated in FIG. 1 according to one implementation of the present disclosure.

FIG. 4 is a block diagram of a computing system suitable for distribution of public/private keys via unikernels according to some implementations of the present disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Recent advancements in computing have led to the proliferation of network-capable computing devices. In particular, the utilization of network-capable edge/Internet-of-Things (IoT) computing devices has increased drastically amongst both commercial and personal users (e.g., virtual assistant devices, smart thermostats, cameras, smart lightbulbs, smart refrigerators, etc.).

When operating, network-capable computing devices may communicate with other computing devices or systems. For example, a virtual assistant device may be a client to a server computing system. The virtual assistant device (i.e., a client computing system) can communicate with the server computing system to obtain weather data requested by a user of the virtual assistant device.

Network-capable computing devices generally attempt to obfuscate their communications to ensure proper security and to protect against attackers. A popular method for obfuscating communications is the usage of encryption via asymmetric key cryptography (e.g., public/private key pairs). For example, a network-capable client computing system may obtain a public key (e.g., from a public key registry, etc.). The client computing system can encrypt data using the public key and transmit the encrypted data to a server computing system that serves the client computing system. The server computing system can decrypt the encrypted data using a private key paired to the public key.

However, the distribution of these public/private key pairs presents a substantial security risk. Particularly, the distribution of keys to edge/IoT computing devices presents an even greater risk, as IoT/edge computing devices can sometimes lack secure network links, or even inherent device security. For example, malicious entities may be able to gain physical access to IoT/Edge computing devices, or may be able to gain access to the network upon which IoT/Edge computing devices communicate (e.g., an unsecured WiFi network, etc.).

Accordingly, implementations of the present disclosure propose the distribution of public/private key pairs via unikernels. As described previously, unikernels are specialized, single-address-space machine images that can be used to store data. In particular, when a unikernel is executed by a computing system, the unikernel can inject the data into the computing system. By utilizing unikernels for key distribution rather than conventional techniques (e.g., remote access, etc.), implementations of the present disclosure can facilitate public/private key distribution while substantially reducing the attack surface, increasing layers of abstraction, eliminating remote access, and reducing the utilization of computing resources.

For example, a public key of a public/private key pair can be stored in a public unikernel included in a public-facing unikernel registry. The corresponding private key of the pair can be stored in a private unikernel included in a private unikernel registry that is accessible to a server computing system that serves a client computing system. The identity of the public unikernel can be indicated to the client computing system so that the client computing system can obtain the public key. An encoding can be generated that identifies the private unikernel storing the private key to the server computing system (e.g., a hash of the public unikernel identifier, etc.). The encoding can be provided to the server computing system so that the server computing system can obtain the private key. In such fashion, the public/private key pair can be distributed to client/server computing systems via unikernels.

The distribution of public/private key pairs via unikernels provides a number of technical effects and benefits. As one example, conventional key distribution via remote access (e.g., Secure Socket Shell (SSH), etc.) provides an additional attack vector to malicious entities. However, key pair distribution via unikernels eliminates the need for remote access, therefore increasing security for client/server computing systems. As another example, each library included in an operating system increases the corresponding attack surface for malicious entities. However, as unikernels only provide an application layer, and only include the libraries necessary to fulfill a function (e.g., storage of a key), the attack surface for attackers is substantially reduced in comparison to conventional techniques, therefore increasing security for client/server computing systems.

As yet another example, conventional techniques for encapsulating keys for distribution generally require the utilization of substantial computing resources. In particular, this required computing resource utilization can be prohibitive to edge/IoT computing devices, which often possess relatively few computing resources (e.g., processor speed, bandwidth, memory, storage, compute cycles, etc.). However, unikernels are extremely lightweight, and can be easily received, stored, and executed by edge/IoT devices, therefore substantially reducing the utilization of computing resources required for key encapsulation while enabling the distribution of keys to edge/IoT devices without remote access.

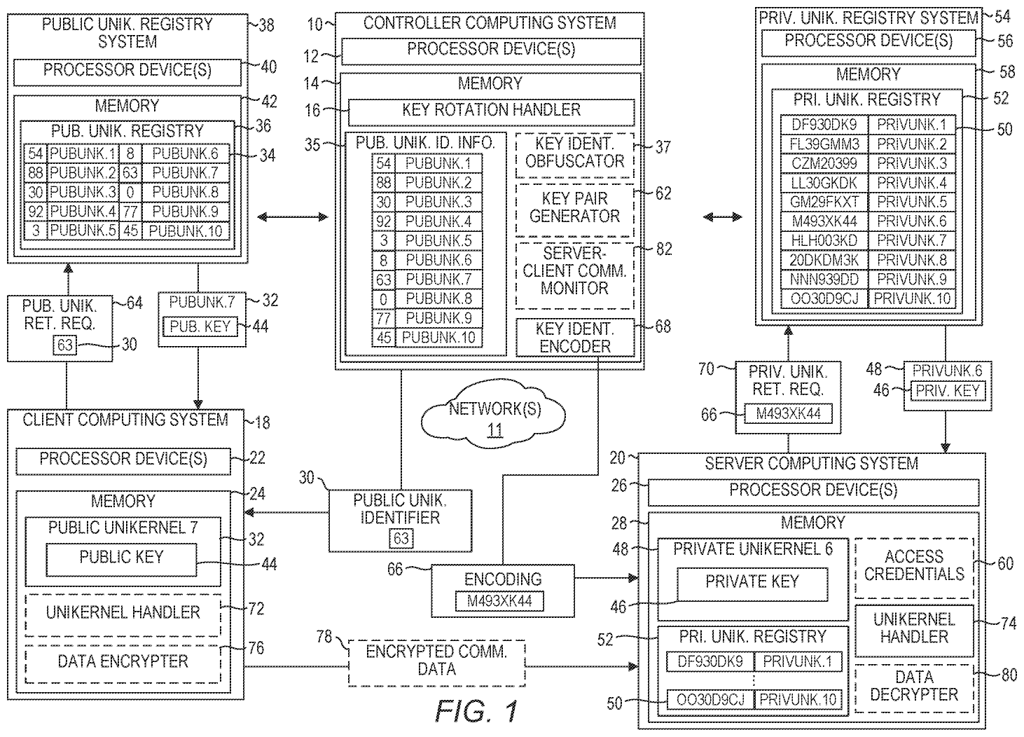

FIG. 1 is a block diagram of an environment suitable for implementing public/private key distribution via unikernels according to some implementations of the present disclosure. A controller computing system 10 includes processor device(s) 12 and memory 14. In some implementations, the controller computing system 10 may be a controller computing system that includes multiple computing devices. Alternatively, in some implementations, the controller computing system 10 may be one or more computing devices within a computing system that includes multiple computing devices. Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.). The memory 14 can include a key rotation handler 16. The key rotation handler 16 can implement functionality for rotation of private and public key pairs for computing systems and/or devices within a server/client architecture. For example, client computing system 18 may be a client to server computing system 20. The key rotation handler can facilitate provision of public keys and private keys to the client computing system 18 and the server computing system 20, respectively.

As described, the client computing system 18 can be a client to the server computing system 20. The client computing system 18 can include processor device(s) 22 and memory 24 as discussed with regards to processor device(s) 12 and memory 14 of the controller computing system 10. Similarly, the server computing system can include processor device(s) 26 and memory 28 as discussed with regards to processor device(s) 12 and memory 14 of the controller computing system 10.

In some implementations, the client computing system 18 may be a subscriber to a service that provides rotation of encryption keys for communication with the server computing system 20. The server computing system 20 may also be a subscriber to the same service. The key rotation handler 16 of the controller computing system 10 can provide key rotation services to subscribers, such as client computing system 18 and server computing system 20.

In some implementations, the controller computing system 10 may determine that a key rotation event has occurred. For example, a key rotation event may occur after a period of time has expired since a last key rotation event. For another example, a key rotation event may occur when a security event occurs (e.g., a malicious entity is detected, a vulnerability is discovered, a more secure method of generating encryption keys is applied, etc.). For another example, a key rotation event may occur when a request for new keys is received by the controller computing system 10 from the client computing system 18 and/or the server computing system 20.

The controller computing system 10 can provide an identifier 30 for a public unikernel 32 to the client computing system 18. The identifier 30 for the public unikernel 32 can be any sort of data that identifies the public unikernel 32 within a plurality of unikernels 34 (e.g., a number, a hash, a string, etc.). For example, the controller computing system 10 can store public unikernel identification information 35 in the memory 14. The public unikernel identification information 35 can include information that associates an identifier to each of the plurality of public unikernels 34.

In some implementations, the controller computing system 10 can generate, or otherwise obfuscate, the identifiers for the public unikernels 34 using the key identifier obfuscator 37. For example, the controller computing system 10 may utilize the key identifier obfuscator 37 to generate a random number as an identifier for each public unikernel (e.g., 63 for public unikernel 7, etc.). For another example, the controller computing system 10 may utilize the key identifier obfuscator 37 to generate an identifier for each public unikernel 34 using a hash function. The controller computing system

In some implementations, the plurality of unikernels 32 may be stored in a public unikernel registry 36 (e.g., a public-facing unikernel registry). Each of the public unikernels 34 may have a corresponding identifier. For example, the public unikernel registry 36 can include a lookup table that associates each public unikernel 34 with a corresponding identifier. Specifically, as depicted, the lookup table may associate the identifier 30 (e.g., “63”) with the public unikernel 7. Alternatively, in some implementations, the identifier 30 may be a cryptographic hash. The public unikernel registry 36 may associate a cryptographic hash with each of the plurality of public unikernels 34.

In some implementations, the public unikernel registry 36 may be stored, or may be accessible by, a public unikernel registry system 38. For example, the public unikernel registry system 38 may include processor device(s) and memory 42 as described with regards to processor device(s) 12 and memory 14 of controller computing system 10. The public unikernel registry system 38 may store the public unikernel registry 36 in the memory 42. Alternatively, the public unikernel registry 36 may be stored in some other memory device (e.g., a network drive, a flash drive inserted to the client computing system 18, etc.).

In some implementations, the controller computing system 10 can provide the public unikernel identification information 35 to public unikernel registry system 38 so that the information can be incorporated into a lookup table of the public unikernel registry system 38. Alternatively, in some implementations, the public unikernel registry system 38 may generate the public unikernel identification information 35 (e.g., for the lookup table) and may provide the public unikernel identification information 35 to the controller computing system 10 to store in the memory 14.

The client computing system 18 can receive the public unikernel identifier 30 from the controller computing system 10. The public unikernel identifier 30 can identify a public unikernel 32. The public unikernel 32 can store a public key 44. The public key 44 can be a key of a public/private key pair utilized for asymmetric cryptography. Specifically, as depicted, the public key 44 can be paired to a corresponding private key 46. The private key 46 can be stored within a private unikernel 48. The private unikernel 48 can be stored along with a plurality of unikernels 50 that are accessible to the server computing system 20.

In some implementations, the plurality of private unikernels 50 can be stored in a private unikernel registry 52. For example, in some implementations, a private unikernel registry system 54 may be accessible to the server computing system 20 (e.g., via network(s) 11). The private unikernel registry system 54 can include processor device(s) 56 and memory 58 as described with regards to processor device(s) 12 and memory 14 of the controller computing system 10. The private unikernel registry system 54 can store the private unikernel registry 52 within the memory 58.

It should be noted that access to the plurality of private unikernels 50 is restricted, and that the plurality of private unikernels 50 are accessible to the server computing system 20. For example, in some implementations, the server computing system may include access credentials 60 that allow the server computing system to access the plurality of private unikernels 50 (e.g., access credentials recognized by the private unikernel registry system 54. Alternatively, in some implementations, the plurality of private unikernels 50 may be stored in the server computing system 20. For example, the server computing system 20 may store, or otherwise implement, the private unikernel registry 52 to store the plurality of private unikernels 50.

In some implementations, the controller computing system 10 may generate key pairs, such as public key 44 and private key 46. For example, the controller computing system 10 may utilize key pair generator 62 to generate key pairs and insert the keys into unikernels. Alternatively, in some implementations, the keys 44 and 46 may be generated by some other system, and that system may provide the public unikernel identification information to the controller computing system 10.

The client computing system 18 can retrieve the public unikernel 32 that stores the public key 44 using the identifier 30. In some implementations, the client computing system 18 may retrieve public unikernel 32 from the public unikernel registry 36. For example, the client computing system 18 may provide a public unikernel retrieval request 64 that includes the identifier 30 to the public unikernel registry system 38. The public unikernel registry system 38 may utilize a lookup table of the public unikernel registry 36 to retrieve the public unikernel 32 based on the identifier 30. The public unikernel registry system 38 may provide the public unikernel 32 to the client computing system 18. The client computing system 18 can store the public unikernel 32 within the memory 24.

The controller computing system 10 can generate an encoding 66 based on the identifier 30 for the public unikernel 32. For example, the controller computing system 10 may utilize key identifier encoder 68 to generate the encoding 66. The encoding 66 can identify the private unikernel 48 storing the private key 46 to the server computing system 20. It should be noted that the encoding 66 can be any sort of encoding sufficient to identify the private unikernel 48 from the plurality of private unikernels 50 (e.g., a cryptographic hash, etc.).

Specifically, in some implementations, the controller computing system can process the identifier 30 with the key identifier encoder 68 to generate the encoding 66. For example, as depicted, the key identifier encoder 68 may process the identifier 30 with a hash function to generate a hash value “M493XK44.” The controller computing system 10 can provide the encoding 66 to the server computing system 20. The encoding 66 can identify the private unikernel 48 to the server computing system 20 (e.g., can allow the server computing system 20 to retrieve the private unikernel 48 from the plurality of private unikernels 50).

In some implementations, the server computing system 20 can retrieve the private unikernel 48 using the encoding 66. For example, the server computing system 20 may send a private unikernel retrieval request 70 that includes the encoding 66 to the private unikernel registry system 54. The private unikernel registry system 54 can retrieve the private unikernel 48 from the plurality of private unikernels 50. For example, the private unikernel registry 52 may include a lookup table that associates the encoding 66 (e.g., the hash “M493XK44”) with the private unikernel 48 (e.g., private unikernel 6). The private unikernel registry system 54 can provide the private unikernel 48 that includes the private key 46 to the server computing system 20.

Alternatively, in some implementations, the server computing system can store the private unikernel registry that includes the plurality of private unikernels 50 within the memory 28. The server computing system can retrieve the private unikernel 48 using the lookup table of the private unikernel registry 52 that associates the encoding 66 with the private unikernel 48.

In such fashion, the controller computing system 10 can facilitate distribution of public/private key pairs (e.g., keys 44 and 46) via unikernels (e.g., unikernels 32 and 48). It should be noted that, as access to the plurality of private unikernels 50 is restricted to the server computing system 20, the security of the key pair 46/48 cannot be broken even if the public key 44 was to be exposed.

For example, even if a malicious entity were to gain access to the public key 44, the malicious entity would not have any way to know the identifier associated with the public key 44, which is obfuscated using the key identifier obfuscator 37. If the identifier 30 and/or obfuscation operations of the key identifier obfuscator 37 were exposed, the malicious entity would still have no way to know the method utilized to generate the encoding 66. Finally, even if the public key 44, the identifier 30, the operations utilized by the key identifier encoder 68, and/or the encoding 66 were exposed, the malicious attacker would still have no way to access the private unikernel registry 52 to retrieve the private key 46. As such, implementations of the present disclosure facilitate public/private key distribution with a minimized attack surface and multiple layers of redundancy, therefore substantially increasing security for communications between the client computing system 18 and the server computing system 20.

It should be noted that, as described herein, a computing system (e.g., controller computing system 10, client computing system 18, server computing system 20, etc.) can be, or otherwise include, any combination of physical and/or virtual components. For example, the client computing system 18 may be a virtualized computing system operable to provide microservices. For another example, the server computing system 20 may utilize virtualized network device(s) to provide services to client computing systems.

In some implementations, the public key 44 and private key 46 can be leveraged by the client computing system 18 and the server computing system 20, respectively, to encrypt and decrypt communication data. For example, the client computing system 18 can retrieve the public unikernel 32 that includes the public key 44 and store the public unikernel 32 in the memory 24. The server computing system 20 can retrieve the private unikernel 48 that stores the private key 46 and store the private unikernel 48 in the memory 28. The client computing system 18 can execute the public unikernel 32 (e.g., using the unikernel handler 72). By executing the public unikernel 32, the public key 44 can be injected into the client computing system 18. Similarly, the server computing system 20 can execute the private unikernel 48 (e.g., using the unikernel handler 74). By executing the private unikernel 48, the private key 46 can be injected into the server computing system 20.

The client computing system 18 can use the injected public key 44 encrypt communication data using data encrypter 76 (e.g., using an asymmetric encryption scheme that leverages the injected public key 44) to obtain encrypted communication data 78. The client computing system 18 can transmit the encrypted communication data 78 to the server computing system 20. The server computing system 20 can receive the encrypted communication data 78 and decrypt the encrypted communication data 78 using the injected private key 46 and data decrypter 80. In such fashion, the client computing system 18 and the server computing system 20 can exchange encrypted, secure communication data using the public/private keys 44/46 stored in unikernels 32/48. In some implementations, the controller computer system 10 can determine that the client computing system 18 and the server computing system 20 have exchanged the encrypted communication data 78 using a server-client communication monitor 82.

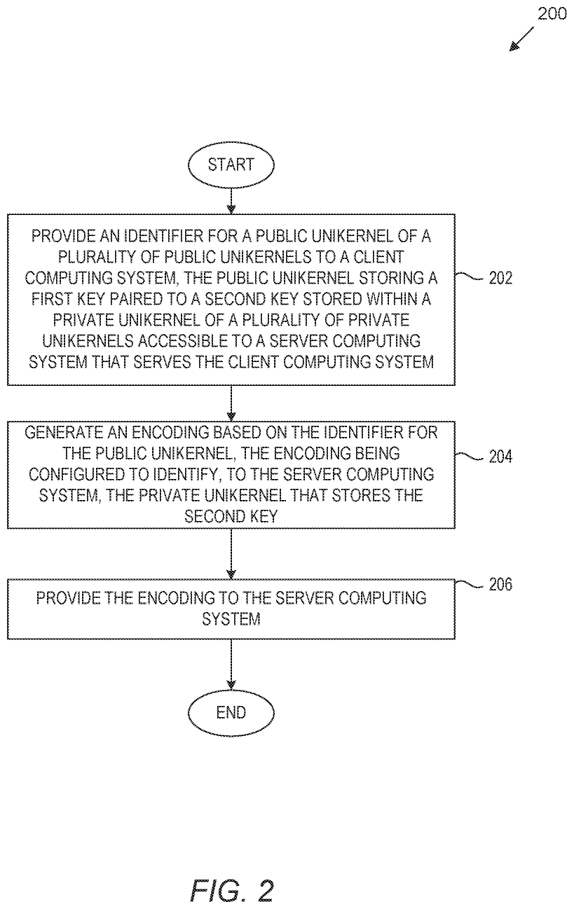

FIG. 2 is a flowchart of a method 200 for distributing public/private key pairs via unikernels according to some implementations of the present disclosure. FIG. 2 will be discussed in conjunction with FIG. 1.

The controller computing system 10 provides an identifier 30 for a public unikernel 32 of a plurality of unikernels 34 to a client computing system 18, the public unikernel 32 storing a first key 44 (e.g., a public key, etc.) paired to a second key 46 (e.g., a private key, etc.) stored in a private unikernel 48 of a plurality of private unikernels 50 accessible to a server computing system 20 that serves the client computing system 18 (FIG. 2, block 202). The controller computing system 10 generates an encoding 66 based on the identifier 30 for the public unikernel 32, the encoding 66 being configured to identify, to the server computing system 20, the private unikernel 48 that stores the second key 46 (FIG. 2, block 204). The controller computing system 10 provides the encoding 66 to the server computing system 20 (FIG. 2, block 206).

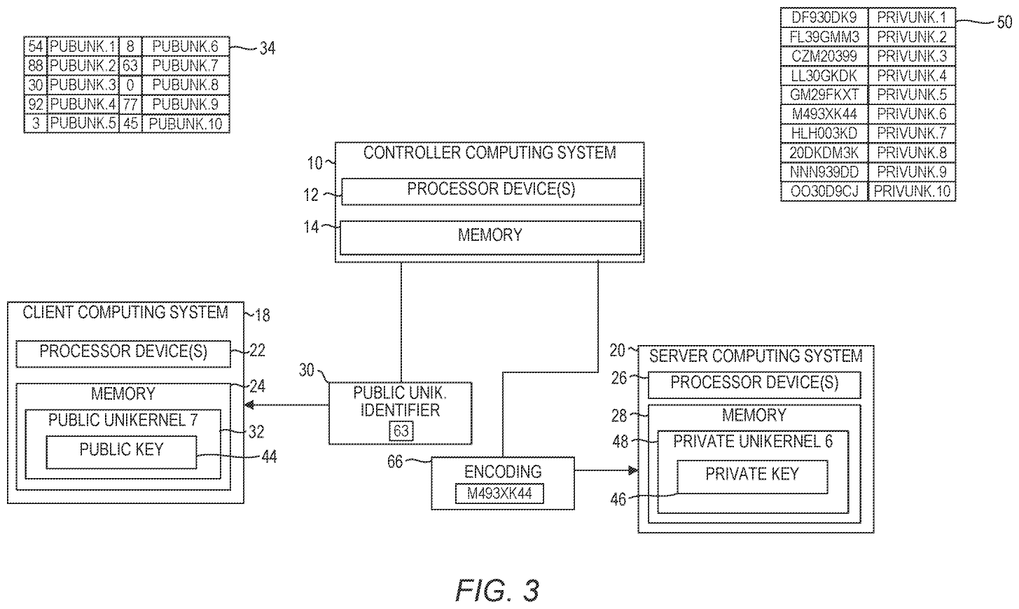

FIG. 3 is a simplified block diagram of the environment illustrated in FIG. 1 according to one implementation of the present disclosure. The controller computing system 10 includes the processor device(s) 12 and the memory 14. The processor device(s) 12 is to provide the identifier 30 for the public unikernel 32 of the plurality of public unikernels 34 to the client computing system 18, the public unikernel 34 storing the public key 44 (e.g., a first key) paired to the private key 46 (e.g., a second key) stored within a private unikernel 48 of a plurality of private unikernels 50 accessible to a server computing system that serves the client computing system 18. The processor device(s) 12 is further to generate an encoding 66 based on the identifier 30 for the public unikernel 32, the encoding 66 being configured to identify, to the computing system 20, the private unikernel 48 that stores the private key 46 (e.g., the second key). The processor device(s) 12 is further to provide the encoding 66 to the server computing system 20.

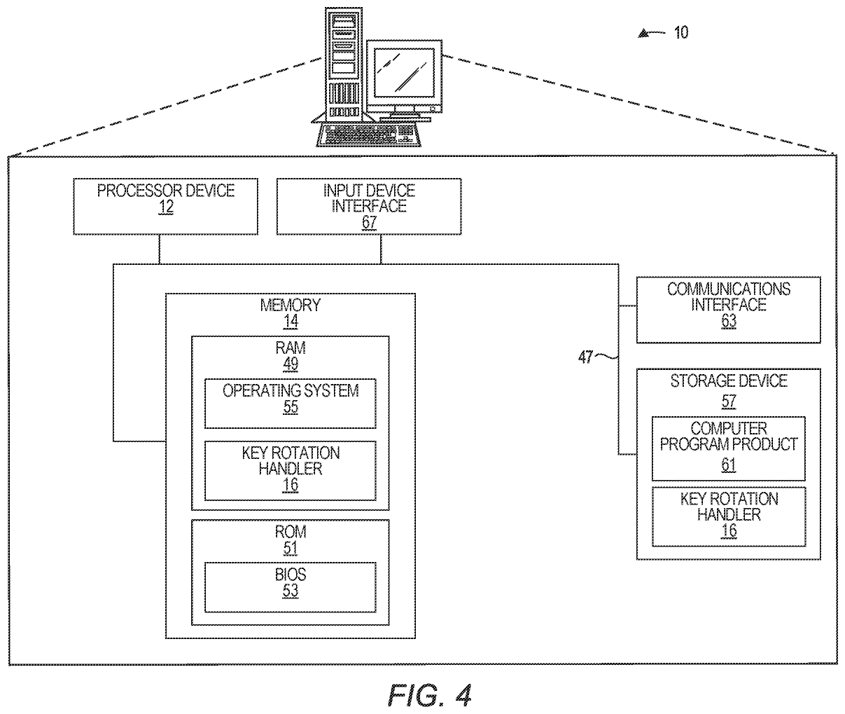

FIG. 4 is a block diagram of a computing system 10 suitable for distribution of public/private keys via unikernels according to some implementations of the present disclosure. The computing system 10 may comprise any computing or electronic device(s) capable of including firmware, hardware, and/or executing software instructions to implement the functionality described herein, such as a computer server, a desktop computing device, a laptop computing device, a smartphone, a computing tablet, or the like. The computing system 10 includes the processor device 12 and a system memory 14, and a system bus 47. The system bus 47 provides an interface for system components including, but not limited to, the system memory 14 and the processor device 12. The processor device 12 can be any commercially available or proprietary processor.

The system bus 47 may be any of several types of bus structures that may further interconnect to a memory bus (with or without a memory controller), a peripheral bus, and/or a local bus using any of a variety of commercially available bus architectures. The system memory 14 may include non-volatile memory 51 (e.g., read-only memory (ROM), erasable programmable read-only memory (EPROM), electrically erasable programmable read-only memory (EEPROM), etc.), and volatile memory 49 (e.g., random-access memory (RAM)). A basic input/output system (BIOS) 53 may be stored in the non-volatile memory 66 and can include the basic routines that help to transfer information between elements within the computing system 10. The volatile memory 49 may also include a high-speed RAM, such as static RAM, for caching data.

The computing system 10 may further include or be coupled to a non-transitory computer-readable storage medium such as the storage device 57, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 57 and other drives associated with computer-readable media and computer-usable media may provide non-volatile storage of data, data structures, computer-executable instructions, and the like.

A number of modules can be stored in the storage device 57 and in the volatile memory 49, including an operating system 55 and one or more program modules, such as the key rotation handler 16, which may implement the functionality described herein in whole or in part. All or a portion of the examples may be implemented as a computer program product 61 stored on a transitory or non-transitory computer-usable or computer-readable storage medium, such as the storage device 57, which includes complex programming instructions, such as complex computer-readable program code, to cause the processor device 12 to carry out the steps described herein. Thus, the computer-readable program code can comprise software instructions for implementing the functionality of the examples described herein when executed on the processor device 12. The processor device 12, in conjunction with the key rotation handler 16 in the volatile memory 49, may serve as a controller, or control system, for the computing system 10 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 12 through an input device interface 67 that is coupled to the system bus 47 but can be connected by other interfaces such as a parallel port, an Institute of Electrical and Electronic Engineers (IEEE) 1394 serial port, a Universal Serial Bus (USB) port, an IR interface, and the like. The computing system 10 may also include the communications interface 63 suitable for communicating with the network 11 as appropriate or desired. The computing system 10 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
providing, by a controller computing system comprising one or more processor devices, an identifier for a public unikernel of a plurality of public unikernels to a client computing system, the public unikernel storing a first key paired to a second key stored within a private unikernel of a plurality of private unikernels accessible to a server computing system that serves the client computing system;
generating an encoding based on the identifier for the public unikernel, the encoding being configured to identify, to the server computing system, the private unikernel that stores the second key; and
providing the encoding to the server computing system.

2. The method of claim 1, wherein the method further comprises:
determining that a key rotation event has occurred;
providing an identifier for a second public unikernel of the plurality of public unikernels to the client computing system, the second public unikernel storing a third key paired to a fourth key stored in a second private unikernel of the plurality of private unikernels;
generating a second encoding based on the identifier for the second public unikernel, the second encoding configured to identify, to the server computing system, the private unikernel that stores the second key; and
providing the second encoding to the server computing system.

3. The method of claim 2, wherein determining that a key rotation event has occurred comprises receiving a request for key rotation from the client computing system and/or the server computing system.

4. The method of claim 2, wherein determining that a key rotation event has occurred comprises detecting a security vulnerability.

5. The method of claim 1, wherein the plurality of private unikernels are stored in a private unikernel registry accessible to the server computing system, wherein the private unikernel registry comprises a lookup table that respectively associates a plurality of encodings to the plurality of private unikernels.

6. The method of claim 5, wherein the plurality of encodings respectively comprise a plurality of hash values.

7. The method of claim 1, wherein the method comprises, prior to providing the identifier for the public unikernel, obtaining a plurality of identifiers respectively associated with the plurality of public unikernels.

8. The method of claim 7, wherein obtaining the plurality of identifiers respectively associated with the plurality public unikernels further comprises obfuscating each of the plurality of identifiers.

9. The method of claim 8, wherein obfuscating each of the plurality of identifiers comprises applying a hash function to each of the plurality of identifiers, and wherein the identifier comprises a hash value.

10. The method of claim 8, wherein each of the plurality of identifiers comprises a random value.

11. The method of claim 1, wherein, prior to providing the identifier for the public unikernel, the method comprises selecting the public unikernel from the plurality of public unikernels.

12. A server computing system, comprising,
one or more processor devices; and
a non-transitory computer-readable storage medium that includes executable instructions to cause the one or more processor devices to:
receive an encoding that identifies a private unikernel of a plurality of private unikernels accessible to the server computing system, the private unikernel storing a second key that is paired to a first key;
execute the private unikernel to obtain the second key;
receive encoded data that is encoded using the first key from a client computing system served by the server computing system; and
decode the encoded data using the second key.

13. The server computing system of claim 12, wherein the plurality of private unikernels are stored in a private unikernel registry accessible to the server computing system, wherein the private unikernel registry comprises a lookup table that respectively associates a plurality of encodings to the plurality of private unikernels.

14. The server computing system of claim 13, wherein executing the private unikernel to obtain the second key comprises:
retrieving the private unikernel based at least in part on the lookup table and the encoding; and
executing the private unikernel to obtain the second key.

15. The server computing system of claim 14, wherein the encoding that identifies the private unikernel is a hash of an identifier for a public unikernel that stores the first key.

16. The server computing system of claim 15, wherein each of the plurality of encodings is a hash value generated from an identifier for a respective public unikernel of a plurality of public unikernels.

17. A non-transitory computer-readable storage medium that includes executable instructions to cause one or more processor devices to:
provide an identifier for a public unikernel of a plurality of public unikernels to a client computing system, the public unikernel storing a first key paired to a second key stored within a private unikernel of a plurality of private unikernels accessible to a server computing system that serves the client computing system;
generate an encoding based on the identifier for the public unikernel, the encoding being configured to identify, to the server computing system, the private unikernel that stores the second key; and
provide the encoding to the server computing system.

18. The non-transitory computer-readable storage medium of claim 17, wherein the executable instructions are to further cause the one or more processor devices to:
determine that a key rotation event has occurred;
provide an identifier for a second public unikernel of the plurality of public unikernels to the client computing system, the second public unikernel storing a third key paired to a fourth key stored in a second private unikernel of the plurality of private unikernels;
generate a second encoding based on the identifier for the second public unikernel, the second encoding configured to identify, to the server computing system, the private unikernel that stores the second key; and
provide the second encoding to the server computing system.

19. The non-transitory computer-readable storage medium of claim 17, wherein determining that a key rotation event has occurred comprises receiving a request for key rotation from the client computing system and/or the server computing system.

20. The non-transitory computer-readable storage medium of claim 17, wherein determining that a key rotation event has occurred comprises detecting a security vulnerability.
